(19) United States
(12) Patent Application Publication
(10) Pub. No.: US 2026/0235222 A1
(43) Pub. Date: Aug. 13, 2026

(54) MODULAR ANTIFREEZE VALVE

(71) Applicant: CALEFFI S.p.A., Fontaneto d’Agogna (Novara) (IT)

(72) Inventor: Marco CALEFFI, Fontaneto d’Agogna (Novara) (IT)

(21) Appl. No.: 19/155,645

(22) PCT Filed: Feb. 13, 2023
(86) PCT No.: PCT/IB2023/051281

§ 371 Date: Aug. 12, 2025

(51) Int. Cl. F16K 31/00

(52) U.S. Cl. CPC F16K 31/002; F16K 2200/501

(57) ABSTRACT

A modular structure antifreeze valve, intended to be installed along a pipe of a conditioning circuit in which an operating fluid circulates, has a valve body on which a pipe portion and a housing portion are obtained; inside the housing portion a thermostat valve is removably housed that includes a thermostat element coupled at a part thereof arranged below in use to a pre-assembled cartridge on which an outlet is obtained and inside which a plug is slidable and is retained open in a draining position for a fluid temperature lower than a limit temperature, and closed for a fluid temperature above the limit temperature. This antifreeze valve is flexible in installation, suitable for assembly of automated type and easy to maintain.

### BACKGROUND OF THE INVENTION

The present invention relates to a modular antifreeze valve intended to be installed along a pipe of a conditioning circuit in which an operating fluid circulates, so as to prevent the operating fluid freezing inside the circuit, damaging it.

### PRIOR ART

Antifreeze valves that are intended to be installed along a pipe of a conditioning circuit in which an operating fluid circulates are known.

Using such antifreeze valves enables water to be used as an operating fluid and, thus, chemical substances that may be dispersed in the environment like, for example, glycol to be avoided.

The aforesaid valves, in detail, include a valve body on which are obtained a pipe portion, which enables the antifreeze valve to be placed in fluid connection with the pipe of the conditioning circuit, and a housing portion inside of which a vacuum breaker device and a thermostat valve are housed in suitable seats obtained in the housing portion.

The thermostat valve, in particular, includes a body on which an outlet is obtained for discharging fluid. In particular, opening and closing of the outlet, and thus discharging or not discharging of the fluid, are controlled by a mechanism, arranged inside the body of the thermostat valve, which controls opening and closing of the aforesaid outlet depending on the temperature of the operating fluid and, in particular, depending on whether the temperature of the fluid is higher or lower than a preset temperature limit.

Typically, the mechanism, whose operation is well known to the expert in the field, features a thermostat element, on which an over-stroke spring urges, which dilates and contracts depending on whether the temperature of the fluid is higher or lower than the limit temperature and accordingly acts on a plug on which an opening spring urges.

The vacuum breaker device, on the other hand, protects the circuit from the formation of vacuum and, at the same time, makes discharging of the fluid more effective when the thermostat valve is open, allowing air to enter when the plant is not pressurized.

In order to operate correctly, the antifreeze valves have to be installed respecting certain restrictions: for example, not only have they to be installed in a prevalently vertical position, i.e. with the outlet facing downwards, so that the discharged fluid can flow down correctly, but also at a high enough height from the ground so as to avoid the formation of the possible column of iced fluid in the zone underneath the valve preventing the fluid from being discharged from the valve.

The aforesaid restrictions, in particular, often make installing an antifreeze valve complicated because the antifreeze valves typically reach a height of about 15 cm in a prevalently vertical position, which dimensions, by virtue of the aforesaid restrictions, are often not compatible with the geometry of the piping of a circuit. In these cases, it is thus necessary to proceed to modify the circuit because any other “solution” adopted (for example positioning the antifreeze valve in a prevalently horizontal manner), could cause malfunctioning of the antifreeze valve and, accordingly, the formation of ice inside the circuit.

Further, it is advisable to install the aforesaid antifreeze valves along both (delivery and return) pipes of the conditioning circuit; nevertheless, it is necessary for the antifreeze valves not to be installed along the same axis (i.e. one above the other); in particular, the outlet of the valve installed above has not to be coaxial with the vacuum breaker device of the other valve otherwise the discharge of the operating fluid of the first valve would obstruct, by freezing, the vacuum breaker of the second valve.

In addition, the assembling of prior art antifreeze valves, and in particular of the thermostat valves included therein, is often inefficient.

This is due to the fact that the mechanism contained in the thermostat valve has to be assembled and positioned manually inside the body of the thermostat valve component by component, and owing to the number and configuration of the components this assembly can be performed only manually.

Similarly, also the maintenance of the prior-art antifreeze valves is inefficient because, in the eventuality that even only one component of the mechanism arranged inside the thermostat valve needs to be changed, it will be necessary to replace all the valve body of the thermostat valve and the mechanism contained therein.

This is in particular due to the fact that opening and closing of the outlet, i.e. discharging or not discharging of the fluid, are calibrated taking into account all the constructional tolerances of the elements that make up the aforesaid mechanism and thus it is not possible to ensure correct operation of the antifreeze valve if one of them is replaced.

### OBJECTS OF THE INVENTION

One object of the present invention is to provide an antifreeze valve provided with great installation flexibility.

A further object of the present invention is to provide an antifreeze valve the structure of which is suitable for assembly of automated type.

Another object of the present invention is to provide a device that makes maintenance of the antifreeze valves more convenient.

### BRIEF DESCRIPTION OF THE INVENTION

The objects listed above are achieved by an antifreeze valve according to the first claim.

### BRIEF DESCRIPTION OF THE DRAWINGS

The invention can be better understood and implemented with reference to the attached drawings that illustrate a non-limiting exemplary embodiment in which:

FIG. 1 is a frontal view of a version of an antifreeze valve according to the invention;

FIG. 2 is a vertical section according to line II-II of the antifreeze valve of FIG. 1;

FIG. 3 is an exploded view of FIG. 2;

FIG. 4 is a perspective view of a further version of an antifreeze valve according to the invention;

FIG. 5 is a perspective view of another version of an antifreeze valve according to the invention;

FIG. 6 is an enlarged frontal view of the antifreeze valve of FIG. 4 installed along a pipe illustrated in dotted lines;

FIG. 7 is an enlarged vertical section according to line VII-VII of FIG. 6 of the antifreeze valve of FIG. 4;

FIG. 8 is a section according to line VIII-VIII of FIG. 7 of the antifreeze valve of FIG. 4;

FIG. 9 is an exploded view of a vertical section according to line VII-VII of FIG. 6 of the antifreeze valve of FIG. 4;

FIG. 10 is an enlarged detail of FIG. 3;

FIG. 11 is an enlarged detail of the aforesaid valves;

FIG. 12 shows, in a vertical section, the operation of the antifreeze valve of FIG. 4.

### DETAILED DESCRIPTION OF THE INVENTION

The antifreeze valve, indicated generically by 10, has a modular structure and is intended to be installed along a pipe of a conditioning circuit in which an operating fluid circulates.

In particular, the antifreeze valve 10 has a valve body 11, made as a single piece, on which a pipe portion 12 and a housing portion 13 are obtained. The valve body 11, in detail, is made of brass, polymer, steel or other materials.

In a further embodiment that is not shown, the valve body 11 is modular.

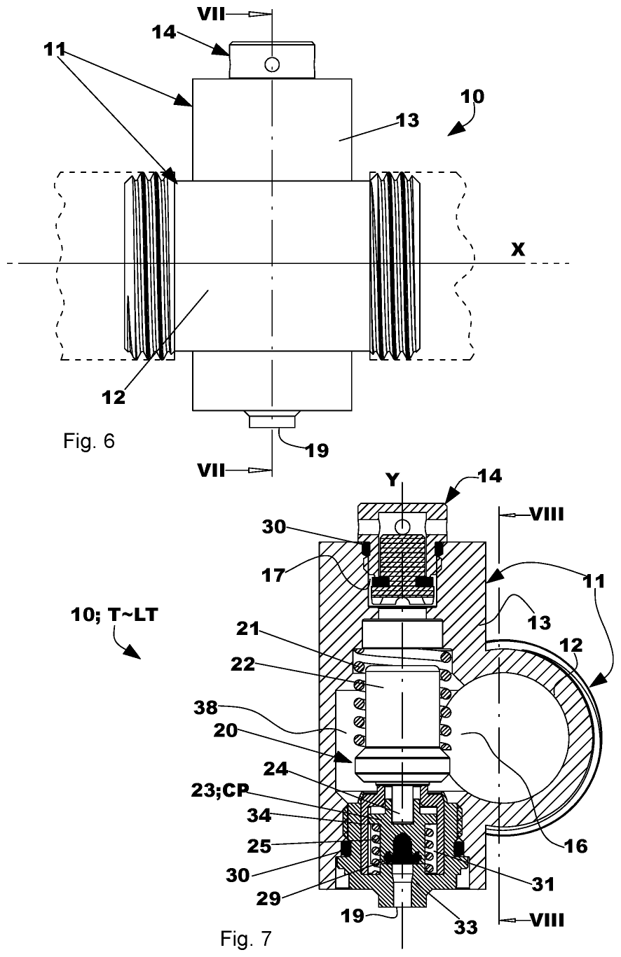

With reference to FIGS. 1,4 and 5, the pipe portion 12 enables the antifreeze valve 10 to be placed in fluid connection with the aforesaid pipe (shown in FIG. 6 in dotted lines) and has an inlet 26 and an outlet 27, which are reversible, for the operating fluid. In the embodiments shown, the inlet 26 and the outlet 27 have the same width.

The pipe portion 12, in addition, extends substantially along a first axis X.

In the exemplary embodiment of the attached figures, the pipe portion 12 has a substantially cylindrical symmetry with respect to the first axis X, i.e. the inlet 26 and the outlet 27 have a circular section; alternatively, the inlet 26 and the outlet 27 can have a square or hexagonal section.

Inside the housing portion 13, on the other hand, a vacuum breaker device 14 and a thermostat valve 15 are removably housed; alternatively, the vacuum breaker device 14 can be positioned directly on the pipe along which the antifreeze valve 10 is installed. In other words, in an alternative embodiment that is not shown, the antifreeze valve 10, and more in particular the housing portion 13, does not include the vacuum breaker device 14.

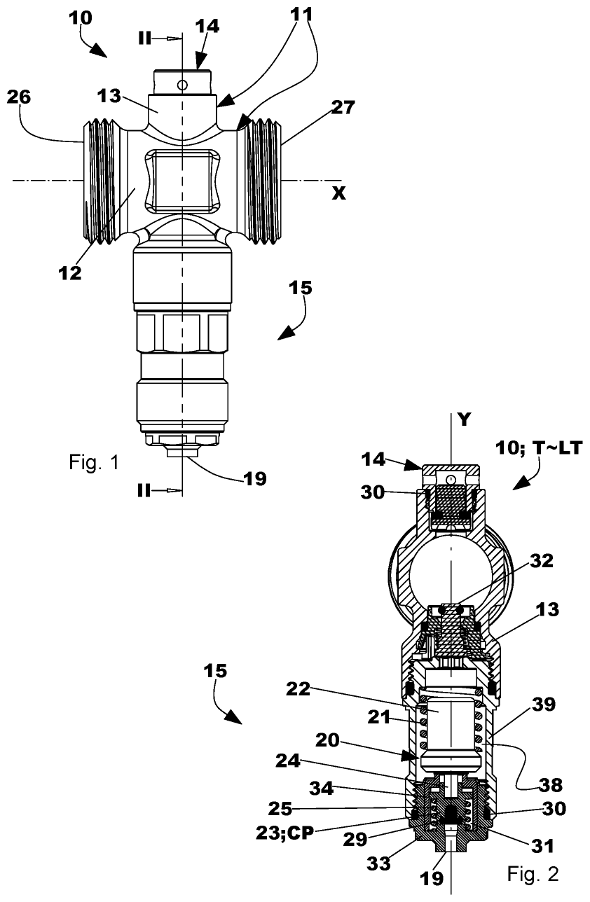

As shown in FIGS. 2, 4, 5 and 7, the housing portion 13 extends substantially along a second axis Y. In particular, the housing portion 13 has a substantially cylindrical symmetry with respect to the second axis Y.

In detail, during use of the antifreeze valve 10, the second axis Y is directed mainly vertically according to the force of gravity and the vacuum breaker device 14 is arranged above the thermostat valve 15.

Reference is now made to FIGS. 1-3, 10 and 11. In the embodiment shown in FIGS. 1-3, the first axis X and the second axis Y are transverse to one another and the pipe portion 12 communicates with the housing portion 13 by a first opening 42 and a second opening 37. In particular, the first axis X and the second axis Y are perpendicular. Further, the first opening 42 and the second opening 37 are substantially opposite and on the same axis with respect to the second axis Y; alternatively, the first opening 42 and the second opening 37 can be offset.

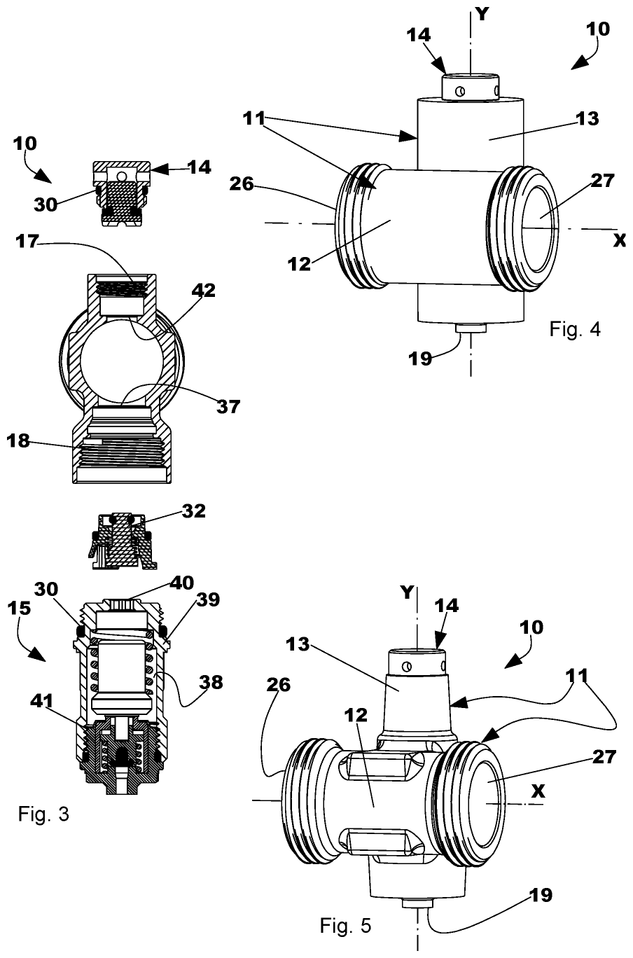

As shown in FIG. 3, the housing portion 13 has a first housing seat 17, inside which the vacuum breaker device 14 is tightened; the first housing seat 17 is thus threaded. In particular, the first housing seat 17 is obtained at the first opening 42 so as to place the vacuum breaker device 14 in communication with the pipe portion 12.

The vacuum breaker device 14 has respective seals 30 so as to ensure a hermetic seal tightening.

Further, the housing portion 13 has also a second housing seat 18, inside which the thermostat valve 15 is tightened; also the second housing seat 18 is thus threaded.

In this version, in fact, the thermostat valve 15 includes a thermostat body 39 that is tightened inside the second housing seat 18 and has a substantially cylindrical symmetry with respect to the second axis Y. A hermetic seal tightening is ensured by respective seals 30 present on the thermostat body 39.

Again with reference to FIG. 3, the thermostat body 39 has a through hole 40 and a third housing seat 41. The third housing seat 41, in particular, is threaded.

When the antifreeze valve 10 is in use, the through hole 40 is placed above the third housing seat 41.

Inside the thermostat body 39 a chamber 38 is obtained in which a thermostat element 20 and a first spring 21 are positioned. The chamber 38 is interposed, in a communicating manner, between the through hole 40 and the third housing seat 41.

As shown in FIG. 2, the thermostat element 20 is coupled with the first spring 21 at a first side 22 thereof. The thermostat element 20, in particular, includes paraffin.

In particular, when the antifreeze valve 10 is used, the first side 22 is an upper part of the thermostat element 20.

The antifreeze valve 10 further includes a pre-assembled cartridge 28 that is removably coupled with the thermostat element 20 at one part 24 thereof, hereinafter called the second side 24, arranged below in use. In particular, the cartridge 28 is tightened inside the aforesaid third housing seat 41. A hermetic seal tightening is ensured by respective seals 30 present on the cartridge 28.

In a different embodiment, which is not illustrated, the cartridge 28 is coupled with the third housing seat 41 by a clip attachment.

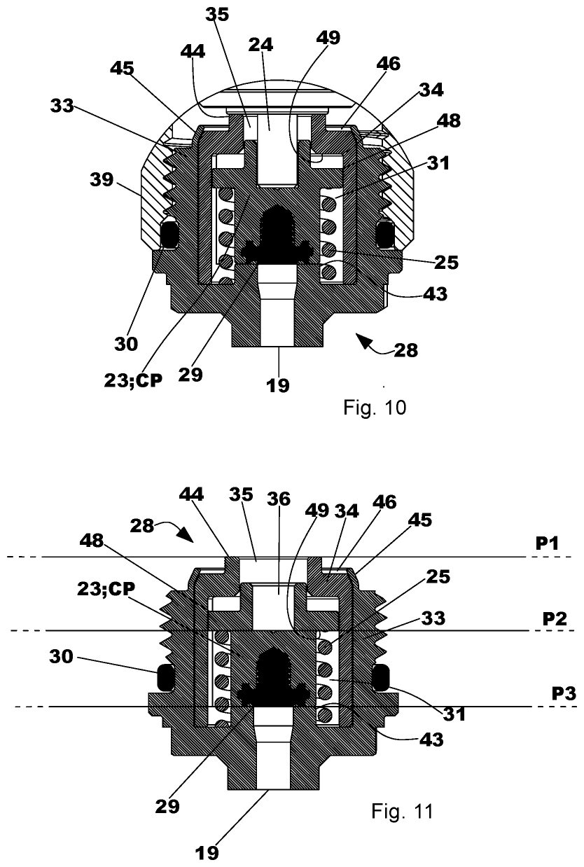

As shown in FIG. 2, and above all in FIG. 10, the cartridge 28, in particular, has substantially cylindrical symmetry with respect to the second axis Y and includes a cartridge body 33 on which an outlet 19 and a cartridge opening 46, that are substantially opposite and substantially on the same axis with respect to the second axis Y, are obtained.

Inside the cartridge body 33, a liner element 34 is arranged defining a sliding chamber 31 inside which a plug 23 is slidable along the second axis Y and is retained; in detail, the sliding chamber 31 has substantially cylindrical symmetry with respect to the second axis Y.

The liner element 34 is locked in position by a partially or totally folded annular end part 45 of the cartridge body 33.

In particular, the liner element 34 is provided with an abutment end wall 49 that retains the plug 23 inside the sliding chamber 31.

Moreover, the plug 23 has an annular abutting protrusion 48.

The outlet 19 is obtained in an annular abutment protrusion 43 that extends, substantially parallel to the second axis Y, inside the sliding chamber 31.

Further, the liner element 34 has a passage 35 at the cartridge opening 46 that, in detail, is substantially centred with respect to the cartridge opening 46 itself.

The passage 35 is obtained in an annular calibrating protrusion 44, substantially opposite and coaxial with the annular abutment protrusion 43.

The plug 23 is coupled with a second spring 25, which is in turn housed inside the sliding chamber 31. The second spring 25 is less stiff than the first spring 21.

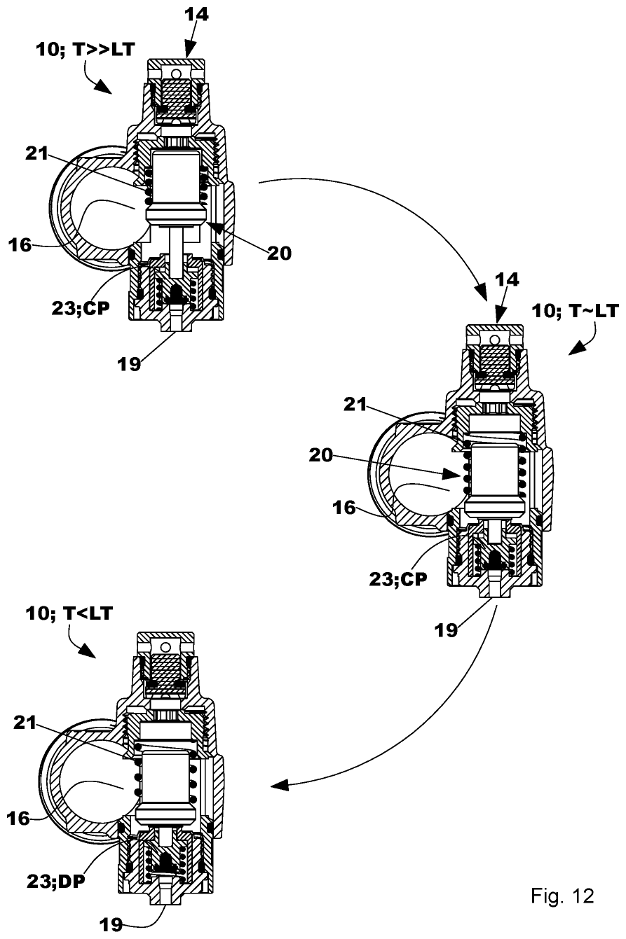

The second spring 25, in detail, is configured to exert an action on the plug 23, along the second axis Y, so as to position the plug 23 in a drainage position DP, illustrated in FIG. 12, for a temperature T of the operating fluid below a preset limit temperature LT. In the drainage position DP, the outlet 19 is open, thus enabling drainage of the operating fluid. In particular, in the drainage position DP the annular abutting protrusion 48 is in contact with the abutment end wall 49.

The thermostat element 20, on the other hand, is configured so as to expand, along the second axis Y, for a temperature T of the operating fluid above or the same as the limit temperature LT. In this manner, the thermostat element 20 exerts an action on the plug 23 that is able to overcome the action of the second spring 25 and then to position the plug 23 in a closing position CP, shown in FIGS. 2 and 12. In detail, in the closing position CP, the outlet 19 is closed by the plug 23 which is provided with a seal 29 that is suitable for ensuring a hermetic seal of the outlet 19 in the aforesaid closing position CP. Even more in detail, in the closing position CP the plug 23 is in contact with the abutment protrusion 43.

The thermostat element 20 exerts the aforesaid action on the plug 23 by a plug protrusion, obtained at the second side 24, that projects coaxially with the second axis Y inside the cartridge 28 through the cartridge opening 46 and the passage 35. The passage 35 is substantially opposite the outlet 19.

Moreover, a blind hole 36 is obtained on the plug 23 so that the plug protrusion of the thermostat element 20 engages inside the blind hole 36, thus coupling the thermostat element 20 with the plug 23.

As shown in FIG. 11, the annular calibrating protrusion 44, in detail, defines a first calibrating plane P1.

Further, the bottom of the blind hole 36, in detail, defines a second calibrating plane P2.

Lastly, the annular abutment protrusion 43 defines a third calibrating plane P3.

Lastly, in the version shown in FIGS. 1-3 the antifreeze valve 10 includes an automatic shut-off valve 32 positioned between the through hole 40 and the second opening 37.

In particular, the aforesaid automatic shut-off valve 32 prevents the discharge of the operating fluid during the replacement of the thermostat valve 15 and/or of the cartridge 28, maintaining the circuit pressurized.

Reference is now made to FIGS. 4-9 and 11. In order to make the description more concise, only the constructional differences between the versions shown in FIGS. 4-9 and the version disclosed previously are disclosed below whereas, for the common parts, the reader is referred to what has been disclosed previously. In particular, the structure of the thermostat valve 15 and of the cartridge 28 will not be disclosed again in detail.

First of all, in the versions shown in FIGS. 4-9, the first axis X and the second axis Y are skew, i.e. they do not lie on the same plane; in particular, the first axis X is orthogonal to the second axis Y.

With reference to FIGS. 7-9, the pipe portion 12 and the housing portion 13 communicate through an opening 16. In detail, the width of said opening 16 is comprised between 5% and 120% of the width of the inlet 26 and of the outlet 27.

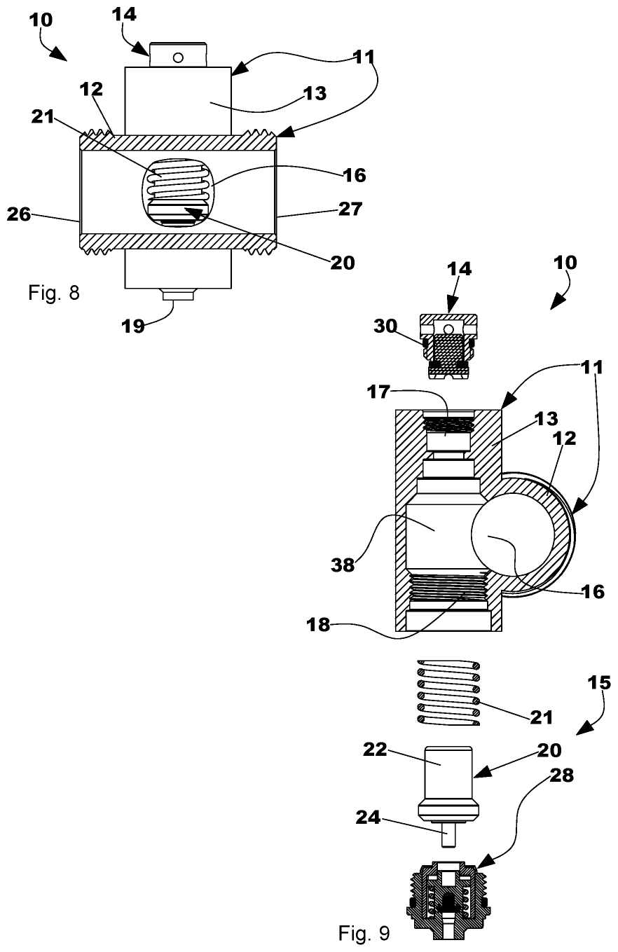

The opening 16 places the thermostat valve 15 in direct contact with the operating fluid traversing the pipe portion 12. More precisely, with reference to FIGS. 7 and 8, the opening 16 puts the thermostat element 20 into direct contact with the operating fluid traversing the pipe portion 12.

Also in these versions, the housing portion 13 includes a first housing seat 17 and a second housing seat 18.

Inside the first housing seat 13, identically to the preceding version, the vacuum breaker device 14 is tightened with respective seals 30 so as to ensure a hermetic seal tightening; otherwise, the cartridge 28 is tightened inside the second housing seat 18, also the cartridge 28 has respective seals 30.

Also in this case, the vacuum breaker device 14 can be positioned directly on the pipe along which the antifreeze valve 10 is installed, thus preventing the antifreeze valve 10, and more in particular the housing portion 13, from including the vacuum breaker device 14.

In the versions shown in FIGS. 4-9 the thermostat valve 15 does not have the thermostat body 39. The thermostat element 20 and first spring 21, are in fact positioned inside a chamber 38 obtained in the housing portion 13 and interposed in a communicating manner between the first housing seat 17 and the second housing seat 18. Further, the chamber communicates, through the opening 16, with the pipe portion 12.

The operation of the antifreeze valve 10 will be disclosed below.

Let us first consider the version of FIGS. 1-3.

In this case, the operating fluid traversing the pipe portion (entering from the inlet 26, and exiting from the outlet 27) flows inside the thermostat valve 15, and in particular inside the chamber 38 of the thermostat body 39, through the automatic shut-off valve 32.

As a result, the thermostat element 20 reacts to the temperature T of the operating fluid contained inside the chamber 38.

In particular, let us consider the eventuality in which the temperature T of the operating fluid is initially equal to the limit temperature LT, and then increases.

In this eventuality, the initially closed outlet 19 remains closed. The plug, in fact, continues to occupy the closing position CP; however, the thermostat element 20 expands.

This expansion, in particular, is controlled by the first spring 21 that thus, inside the antifreeze valve 10, acts as an over-stroke spring. The first spring 21, in fact is stiffer than the second spring 25 so that the first spring 21 is compressed only for temperatures T above the limit temperature LT, i.e. only when the plug 23 occupies the closing position CP.

At this point, let us consider the case in which the temperature T of the operating fluid moves from a value above the preset limit temperature LT to a value below the limit temperature LT.

The thermostat element 20 clearly shrinks. In particular, during the cooling step in which the temperature T reaches the preset limit temperature LT, the first spring 21 is decompressed and the plug 23 occupies the closing position CP; nevertheless, by virtue of the greater stiffness of the first spring 21, when the temperature T falls below the limit temperature LT, the shrinkage of the thermostat element 20 enables the second spring 25 to extend and, in this manner, move the plug 23 from the closing position CP to the drainage position DP; i.e. the outlet 19 is opened, thus enabling the operating fluid to be drained.

The vacuum breaker device 14 makes the fluid drainage more effective.

Operation of the versions shown in FIGS. 4-9 differs from that previously disclosed as the operating fluid traversing the pipe portion 12 comes into contact with the thermostat element 20 through the opening 16. In particular, this situation is illustrated in FIG. 12.

This difference is, in particular, reflected in the response time of the antifreeze valve 10.

In fact, in the version of FIGS. 1-3, the operating fluid flows slowly inside the thermostat valve 15, so that the temperature perceived by the thermostat element 20, actually, is not the actual temperature of the operating fluid traversing the pipe portion 12 but, more correctly, it is a temperature determined by convective motions that occur inside the chamber 38 obtained in the thermostat body 39.

Otherwise, in the embodiments shown in FIGS. 4-9, the opening 16 enables a direct contact to be defined between the thermostat element 20 and the operating fluid traversing the pipe portion 12, without this causing enormous load losses.

From what has been disclosed above, the antifreeze valve 10 achieves all the set objectives, overcoming the drawbacks of the prior art.

In particular, the cartridge 28 is compact. This enables to obtain an antifreeze valve of considerably reduced dimensions compared with those available today on the market and the installation flexibility of an antifreeze valve to be thus increased. Even more in particular, the versions shown in FIGS. 4-9 enable two antifreeze valves to be installed coaxially, i.e. one on top of the other respectively along the delivery and return pipes, having the common sense to install them in a mirror manner in relation to the common axis.

Furthermore, the antifreeze valve 10 has a structure that is suitable for assembly of automated type owing to the presence of a preassembled cartridge containing a large part of the mechanism of the thermostat valve. This, in particular, enables the time for assembling an antifreeze valve to be reduced.

In addition, the antifreeze valve 10 enables more focused maintenance tasks to be performed.

In fact, in prior-art antifreeze valves, as anticipated, opening and closing of the outlet, i.e. discharging or not discharging of the fluid, are calibrated taking into account all the constructional tolerances of the elements that make up the aforesaid mechanism and thus it is not possible to ensure the correct operation of the antifreeze valve if one of these is replaced.

Nevertheless, this drawback is overcome owing to the particular conformation of the pre-assembled cartridge 28: in fact, in this case, correct calibration of the fluid discharge mechanism depends only on the corresponding distances between the first calibrating plane P1, the second calibrating plane P2 and the third calibrating plane P3, which are easily repeatable in series.

Therefore considering the case in which it is necessary to replace the over-stroke spring, it will be sufficient to provisionally remove the cartridge 28 and it will be possible to selectively replace the over-stroke spring.

Otherwise, in the eventuality that an element contained inside the cartridge 28 is damaged, it will be sufficient to replace the cartridge 28 with another one.

1. Modular structure antifreeze valve, intended to be installed along a pipe of a conditioning circuit in which an operating fluid circulates, comprising a valve body on which a pipe portion is obtained to put said antifreeze valve in fluid connection with said pipe of said conditioning circuit, said pipe portion having an inlet and an outlet, which are reversible, for said operating fluid and extending substantially along a first axis, and comprising a housing portion inside which a thermostat valve is housed removably, said housing portion extending substantially along a second axis, wherein said thermostat valve includes a thermostat element that is coupled at a first side thereof with a first spring, wherein said thermostat valve comprises a pre-assembled cartridge, said thermostat element being removably coupled at a second side thereof with said cartridge, which comprises a cartridge body on which an outlet and a cartridge opening are obtained, on the same axis with respect to said second axis, and inside which a liner element is arranged, which is locked in position, defining a sliding chamber inside which it is slidable along said second axis, and is retained, a plug coupled with a second spring, in turn housed inside said sliding chamber, said second spring being configured to exert an action on said plug, along said second axis, so as to position said plug in a drainage position, for a temperature of said operating fluid below a set limit temperature, in which said opening is open, thus enabling said operating fluid to be drained, and wherein said thermostat element is configured so as to expand, for a temperature of said operating fluid above or the same as said limit temperature, along said second axis, exerting in this manner an action on said plug that is able to overcome the action of said second spring and position said plug in a closed position in which said outlet is closed by said plug, the latter comprising a seal suitable for ensuring an hermetic closure of said outlet when said plug is in said closing position.

2. Antifreeze valve according to claim 1, wherein said thermostat element, at said second side, has a plug protrusion that protrudes substantially parallel to said second axis inside said cartridge through a passage, obtained in an annular calibrating protrusion of said liner element, the latter being locked in position by a partially or totally folded annular terminal part of said cartridge body, and positioned at said cartridge opening, which is substantially opposite said outlet, and wherein in said plug a blind hole is obtained, said plug protrusion engaging inside said blind hole obtained on said plug so as to couple said thermostat element with said plug.

3. Antifreeze valve according to claim 1, wherein said plug is provided with an annular abutting protrusion and wherein said outlet is obtained in an annular abutment protrusion that extends, substantially parallel to said second axis, inside said sliding chamber, said plug, in said closing position, being in contact with said annular abutment protrusion and said annular abutting protrusion being, in said drainage position, in contact with an abutment end wall of said liner element, which further retains said plug inside said sliding chamber.

4. Antifreeze valve according to claim 1, wherein said first axis and said second axis are skew, i.e. they do not lie on the same plane, said pipe portion and said housing portion communicating through an opening so as to place in direct contact said thermostat valve with said operating fluid traversing said pipe portion.

5. Antifreeze valve according to claim 4, wherein said opening is positioned so as to place in direct contact said thermostat element with said operating fluid traversing said pipe portion.

6. Antifreeze valve according to claim 5, wherein said housing portion comprises a first housing seat inside which a vacuum breaker device is tightened and a second housing seat inside which said cartridge is tightened, said cartridge and said vacuum breaker device comprising respective seals suitable for ensuring hermetic seal tightening, and wherein said thermostat element and said first spring are positioned inside a chamber obtained in said housing portion and interposed in a communicating manner between said first housing seat and said second housing seat, said chamber further communicating through said opening with said pipe portion.

7. Antifreeze valve according to claim 4, wherein said inlet and said outlet have the same width, and the width of said opening is comprised between 5% and 120% of the width of said inlet and of said outlet.

8. Antifreeze valve according to claim 1, wherein said first axis and said second axis are transversal to one another, said pipe portion and said housing portion communicating by a first opening and a second opening, said first opening and said second opening being substantially opposite and on the same axis with respect to said second axis.

9. Antifreeze valve according to claim 8, wherein said housing portion comprises at said first opening a first housing seat, inside which a vacuum breaker device is tightened, and at said second opening a second housing seat, said thermostat valve further comprising a thermostat body tightened inside said second housing seat and having substantially cylindrical symmetry with respect to said second axis, inside said thermostat body, a chamber being further obtained inside which said thermostat element and said first spring are positioned, said vacuum breaker device and said thermostat body comprising respective seals suitable for ensuring hermetic seal tightening.

10. Antifreeze valve according to claim 9, wherein said thermostat body has, on the same axis with respect to said second axis, a through hole and a third housing seat inside which said cartridge is tightened, said cartridge comprising respective seals suitable for ensuring hermetic seal tightening, and wherein said chamber is interposed, in a communicating manner, between said through hole and said third housing seat.

11. Antifreeze valve according to claim 10, further comprising an automatic shut-off valve positioned between said through hole and said second opening.

12. Antifreeze valve according to claim 1, wherein said first spring is stiffer than said second spring.

13. Antifreeze valve according to claim 1, wherein said thermostat element comprises paraffin.

14. Antifreeze valve according to claim 1, wherein said valve body is made of a material from a group comprising brass, steel and plastics.
